(19) United States
(12) Patent Application Publication
(10) Pub. No.: US 2009/0053681 A1
(43) Pub. Date: Feb. 26, 2009

(54) INTERACTIVE LEARNING METHODS AND SYSTEMS THEREOF

(75) Inventors: Ping Wen SHEN, Taipei (TW); Chi Hsiung Yang, Taipei (TW); Chih Fan Lin, Taipei (TW)

Correspondence Address: Jenny Chen, 7F, No. 1, Alley 30, Lane 358, Rueiguang Road, Neihu District, Taipei, 114, TW

(73) Assignee: Triforce, Co., Ltd.

(21) Appl. No.: 12/186,539

(22) Filed: Aug. 6, 2008

Related U.S. Application Data
(60) Provisional application No. 60/963,604, filed on Aug. 7, 2007.

(51) Int. Cl. G09B 19/06; G09B 5/00; G09B 19/04

(52) U.S. Cl. 434/157; 434/169; 434/158

(57) ABSTRACT

A language learning method is disclosed. The method includes providing a persistent environment such that when a player enters the persistent environment, an interaction between the player and the persistent environment is based on the player's level of a language skill.

### CROSS-REFERENCE TO RELATED APPLICATIONS

This application is related to and claims priority to U.S. provisional patent application, U.S. Provisional Application No. 60/963,604, filed on Aug. 7, 2007, by the applicants Ping Wen Shen, Chi Hsiung Yang, and Chih Fan Lin, entitled “Interactive learning method and system thereof.”

### FIELD OF THE INVENTION

The present invention relates to interactive learning methods and systems thereof, more particularly, the present invention relates to an interactive learning methods and systems thereof utilizing massively multiplayer online game (MMOG) to learn foreign languages.

### BACKGROUND OF THE INVENTION

Generally, people learn by being immersed in an environment and having repeated exposure to the things they are learning. For example, people learn their native language naturally by being immersed in that native language environment where they constantly have the opportunities to hear, speak, see and use that language. However, when it comes to learning a foreign language, this natural learning approach is seldom utilized.

Traditionally, foreign language learning is mostly done in a control environment where a teacher would teach the language by explaining the basic characters and grammar rules and pronouncing the vocabularies repeatedly until students understand. Quizzes and exams are normally given regularly to ensure the students' level of skills. However, these tests may create adverse effects to the students who are learning a new language. The students may not speak the foreign language after class and thus can hardly speak the foreign language as fluently as their native tongue. For those students who are shy to talk in class, there's even a less chance for improvement.

Since the popularity of computer and the Internet has spread, E-learning or computer assisted instructions (CAI) have become a major source to learn foreign languages. Online classroom with video conferencing is provided to help simulate a real classroom experience. Although the lesson may be individualized and may be available 24 hours a day, the students may still lack motivation to improve their foreign language skills. Additionally, the artificial intelligence is too simple to provide a true real world classroom experience.

As people are more into the virtual world created on the Internet nowadays, it is desirable to provide an interactive learning environment that would assist and motivate people to learn foreign languages in a quasi-natural learning approach. It would also be advantageous to provide an interactive learning method that would assist and motivate people to learn a foreign language by engaging people in what they enjoy doing such as playing an online game. Additionally, it would be advantageous to provide an interactive learning method that would allow people to learn a foreign language in practical context environments. Furthermore, it would be advantageous to provide an interactive learning system that may not only provide upgradeable learning contents but also recognize learners' speech so as to enhance their speaking skill.

### SUMMARY OF THE INVENTION

In light of the drawbacks of the above prior arts, one object of the present invention is to provide an interactive learning method utilizing a massively multiplayer online game (MMOG) as a learning environment.

Another object of the present invention is to provide an interactive learning method having a real-time online interaction, wherein the real time online interaction may include an online facilitator, an online auditor, an online tutor, a language learning institute, a real-time event editor, a business development function organizer, or any combination thereof.

Yet another object of the present invention is to provide an interactive learning method having a game plan, wherein the game plan may include utilizing a massively multiplayer online role playing game (MMORPG) as the learning environment. The MMORPG may include a three-dimensional virtual scene and multiple players, a virtual role play, a virtual economy, a virtual group of characters, a game, a competition, a club, a virtual pet, a friend list, a set of adventure quests, a set of events, a user customizable avatar, a user customizable virtual space, or any combination thereof. The game may be featured as several rounds of games and/or real-time games. The MMORPG may be story-oriented so as to motivate players to learn. Additionally, the game plan may incorporate voice functions into the game. The voice functions may be carried out using a personal communication device. Alternatively, the voice functions may be carried out in the form of an animated object. Or, the voice functions may be carried out in the form of a rhythm-based voice competition. The game plan may further include a parent-and-kid platform, wherein the parent-and-kid platform may provide a blog, a three-dimensional communication booklet, a reward program, a parent-and-kid competition, a learning history and inquiry, a monitoring client program or any combination thereof.

Yet another object of the present invention is to provide an interactive learning method having a program plan, wherein the program plan may be user-oriented. The program plan may adopt a natural learning approach, a direct teaching approach, a listening and speaking approach, a group learning approach, or any combination thereof. The program plan may be designed with computer-assisted instructions (CAI).

Yet another object of the present invention is to provide an interactive learning system integrating voice over IP (VoIP), automatic speech recognition (ASR), back-end system, data storage system, accounting system, text-to-speech (TTS), hardware integrated circuit (IC) solution, knowledge management, real-time event editor function, or any combination thereof to facilitate interaction and/or enhance learner's foreign language skill.

Still another object of the present invention is to provide a digital signal processor integrating voice over IP and speech recognition as well as text-to-speech functions on the same chip; as a result, less system resource is needed on a user's PC, thereby reducing the loading on the PC.

Still another object of the present invention is to provide an interactive learning system implementing the MMOG or MMORPG as the learning environment.

Still another object of the present invention is to provide an interactive learning application utilizing the MMOG or MMORPG as the learning environment.

Still another object of the present invention is to provide a personal communication device selectively used to interact with a persistent environment. The personal communication device may include a main body utilized as a tool to interact the persistent environment to assist a player in learning a language; a headset selectively used with the main body so as to provide audio capabilities; a connecting base communicating with the main body and the headset so as to transmit an input to the persistent environment, wherein the main body may be installed with a digital signal processor such that the player interacts with the persistent environment through voice, and when the player is playing one of a plurality of learning modules within the persistent environment, the main body is plugged in the connecting base.

### BRIEF DESCRIPTION OF DRAWING

FIG. 1 is a flow chart of an interactive learning method in accordance with a first embodiment of the present invention.

### DETAILED DESCRIPTION OF THE INVENTION

In accordance with the present invention, the interactive learning method may be implemented in a persistent environment having on-going activities regardless whether a particular individual enters or exits the environment. For example, the persistent environment of the present invention may mimic the real world, where a plurality of activities happens at any given time such that when the individual enters the persistent environment, the individual may look for activities to participate or initiate an activity as he or she wishes. However, the activities in the persistent environment do not need to end as the individual exits the environment. Instead, the activities may continue with other participants, and the individual may join in at a later time and follow any new development that may have happened when the individual was away, just like a real world.

In a preferred embodiment of the present invention, the persistent environment may adopt the massively multiplayer online gaming (MMOG) platform as the learning environment. The learning environment may be created as a community that provides unparalleled interactive experiences and achieve true interaction. The community may allow the learner (also referred to as the student, the user or the player) to participate in changing events that may at any given time be full of surprises, planned or unplanned due to the number of players. The community may be depicted with vivid graphics and sounds and allow the player to buy, sell and trade items and share items among other players just like in the real world. The community may activate a voice over IP (VoIP) engine to enable instant chat so that speaking skills may be practiced. This community would also motivate the learner to repeatedly return to the community.

Take foreign language learning as an example. For a Chinese native speaker to learn English, the present invention may create a scenario as if the Chinese player is visiting New York City in the United States. In the scenario, an avatar representing the Chinese player may be depicted as a tourist or a business traveler, and the player may be approached by other players, who may be an English speaking character or a foreign language native speaking player, to have a conversation, or vice versa. Consequently, the player may listen and speak English as various events unroll.

In accordance with the present invention, scenarios and stories may vary (planned or unplanned) to create excitement for the learner. Additionally, other players, who may be Chinese native speakers or other language speakers, may also be in the same scenario to learn English so that they can team up for a variety of activities. For example, players may experience shopping on the Fifth Avenue, visiting the Statue of Liberty, attending a business meeting, or attending a Broadway show. In this way, the players may learn and enhance their English language skill naturally and with fun through role-play. And players may learn the language in eager in repeated returns.

In another example, via a concept of virtual immigration, players are brought abroad to the multicultural city of New York. Players may visit famous stores virtually and experience numerous innovative gadgets. With the aid of these gadgets, players will interact with New-Yorkers and other people online to learn and enhance their English capabilities; together, they will compete and achieve a sense of accomplishment through numerous online and offline competitions.

In yet another example, the present invention may be utilized to help reduce anxiety or even fear in a person. For example, a user may feel anxious before traveling alone to a foreign place for the first time. The present invention provides a quasi-natural learning environment where the user may experience the travel virtually before the actual travel.

As the persistent environment is continuous, and may be created, initiated, and participated in any way or any time, any real time experience may be learned.

As a result, in order to achieve true interaction among the learners, the present invention is preferably implemented in a multi-client environment such that multiple users can learn interactively and as if they are playing an online game. However, it should be noted that the present invention may also adopt any similar virtual environment where a player may learn interactively with a non-player character, such as an online facilitator or artificial intelligence.

In accordance with the present invention, the interactive learning method may provide a real-time online interaction. Real-time online interaction may involve an online facilitator. The online facilitator may provide all kinds of interaction. In the English learning example, the online facilitator may be a native English speaker providing live in-game interaction. To help the learner to practice English, the online facilitator may actively look for players to speak English with. Alternatively, the online facilitator may be passively sought by the players for interaction.

In accordance with the present invention, the interactive learning method may adopt the MMORPG as the learning platform. The MMORPG may further include a three-dimensional virtual scene and multiple players for interactive experiences. The players may form groups, compete with one another, compete with other groups, perform certain role-plays and go on adventures or accomplish tasks separately or together. In the virtual immigration example mentioned above, the scene may be depicted as a virtual copy of New York City. Players visiting the toy store in the scene may also be as if they're visiting the real store. As mentioned before, the MMORPG may provide a virtual economy where the player can buy, sell and trade items so as to learn about business in the real world and in the language the players' are learning.

Again, take the English learning example, the players may go through business transactions with one another in English, or the online facilitator may teach the players various business topics in English so that the players may learn a certain topic in an English-speaking environment. In particular, in the virtual immigration example mentioned above, players may buy toys in the toy store with in-game points, which are acquired as rewards from completing game sequences, so that English can be practiced as they complete the purchase.

Additionally, the MMORPG may allow the players to form clubs or groups so that they may participate in group-only competition or missions. In order for the players to have more fun learning interactively with their friends, the MMORPG may also allow the players to bookmark and contact other players in long distance through a friends list.

Furthermore, the MMORPG may provide game features in both “player versus player” and “player versus AI” competitions. The purpose of a competition may be to help the player remember new vocabularies, phrases, sentences, usages and grammars. For example, in this competition system, pictures corresponding to certain vocabularies, phrases, sentences, usages and grammars may be shown for the players to speak and/or spell out in English. Furthermore, a series of vocabularies and/or phrases and/or sentences and/or usages and/or grammars may be tested for a given time period so that whoever can answer the most question wins the competition. Alternatively, phrases and longer sentences may also be tested in the competition to help improve the players speaking capabilities. Moreover, a reward program may be associated with the game features so as to make the learning environment more fun, and in turn motivates the players to learn.

In accordance with the present invention, the MMORPG may provide a quest system. The quest system may hold a plurality of quests, and each quest may be equivalent to a learning lesson. The quest system may be initiated through interaction with other characters, such as a non-player character or an online facilitator. To make the lesson more interesting, a variety of mission objectives, such as item delivery, puzzle solving, and treasure hunting, may be created. Each mission may involve the players practicing their listening, speaking, writing, and/or reading skills. To control the difficulty of the mission, the content of each lesson is strategically placed under story-driven scenarios. Furthermore, different levels of quests may be catered to player's learning progress.

Take the English learning example; three levels may be set, namely, novice, intermediate, and advance. At the novice level, there may be a native language voice-over with English keywords and keyword pictures; at the intermediate level, there may be English voice-over with English keywords and keyword pictures; and at the advance level, there may be only English voice-over. A reward program may also be associated with the game features so as to make the learning environment more fun, and in turn motivates the players to learn.

In accordance with the present invention, the game plan may incorporate voice functions into the game. In one embodiment, the voice functions may be carried out using a personal communication device (PCD). In one embodiment, the PCD may be a physical main game gadget for the player. In a preferred embodiment, the PCD may include a headset, a main body, and a connecting base. The voice function may be incorporated within the PCD to facilitate the language learning experience.

In accordance with the present invention, the PCD may have a counterpart in the persistent environment. In a preferred embodiment, the counterpart may be shaped in the same as the PCD such that the player may operate the counterpart in the persistent environment the same way as he or she would operate the PCD in the real world.

In one embodiment, the PCD may be used as an environment scanner, energy absorbing device, mobile phone, dictionary, quest journal, GPS, MP3, or accessories storage device, assisting the players to learn during gameplay.

In accordance with the present invention, the game plan may incorporate a virtual pet system, which may be called FABO, that works in tandem with the PCD.

In one embodiment, the FABO may be the virtual pets that players can catch, collect, train, battle, and used as quest helper to identify objects and situational contexts in English throughout the game. Additionally, the FABO may change shape and adapt new functions or battle skills according to the player's progress of game and role-playing.

In another embodiment, the PCD may be both an online and offline device. When the PCD is operated as an online device, the PCD may be used in-game as a medium between the player and their FABOs, giving the player super power abilities to assist the player to learn. Alternatively, when the PCD is operated as an offline device, the PCD may be a hardware device consists of a headset, a main body containing speech recognition and VoIP integrated chipset, and a connecting base for the headset, the main body, and a data link line that may be connected to the computer during online game play to upload and download English and game data.

In a preferred embodiment, during offline usage, the PCD may be a stand-alone device where players can verbally practice English vocabularies/phrases/sentences downloaded from the game's progress, and earn virtual points on the PCD. The virtual points earned during offline usage may be uploaded to the online game when the PCD is connected to the MMORPG platform.

In one embodiment, the PCD may act as a pronunciation practice machine. These virtual points may be accumulated in games to purchase game items or allow player to participate in special events. As a stand along device, the PCD may have onboard rechargeable battery for mobile use when players carry the main body with them wherever they go. The voice function may be incorporated within the PCD's main body to facilitate continual language learning experience offline.

In one embodiment where the PCD is used as a dictionary, mobile phone, or GPS, for example, the PCD may work separately from the MMOG platform. In other words, the PCD may work in an online or offline status in relation to the MMOG platform. Taking English learning as an example, the player may use the PCD separately, namely in the offline status, to identify objects in English and review each vocabulary using the PCD. Alternatively, the player may also use the PCD within the MMOG platform to learn vocabularies in a similar manner. For example, players may use the PCD to direct their FABO over an object, and the pronunciation, spelling and the like of the object may be given by FABO to assist the players to learn.

In the preferred embodiment, whether the PCD's main body is plugged into the connecting base may be used to determine whether the FABO is working separately from the MMOG platform or not. For example, if the PCD's main body is plugged into the connecting base, the FABO may be considered as a tool to assist the player to learn within the persistent environment. On the other hand, if the PCD's main body is not plugged into the connecting base, the PCD and FABO may be considered as a separate device helping the player to learn and/or review the language in the offline environment.

Additionally, the FABO may link players to various game modules to help players learn interactively. For example, in one of the game modules, the player may encounter special “monsters.” The special monsters may be animated objects with personified characteristics, such as cups, pots, bags, shoes, etc. During an encounter, the player may launch his or her own FABO to compete in order to learn the task such special monster was designed for. In one embodiment, this game module may be turn-based voice action sequences. The game module may have voice commands that are learning contents, and thus the players may learn the contents naturally as they play the game and follow the learning contents. Additionally, the voice commands may have different levels of difficulty. For example, difficulty may be classified as beginner, intermediate and advance. The learning content may thus be presented accordingly.

In accordance with the present invention, the game module may also selectively enable a speech recognition engine. For example, in an advanced level, the game module may require a native speaker-like pronunciation in order to win the competition. Furthermore, the game module may allow additional attributes on the player's and non-player characters for variety and personality. The game module may provide reward points depending on the result of the game.

In one embodiment, the game module is for a player and a non-player character to compete. In another embodiment, the game module is for competition between online players. In a preferred embodiment, the game modules may be downloaded onto the personal communication device (PCD) such that the games may be played in a similar manner when the player is not in the online environment. Furthermore, the personal communication device may synchronize with the online environment such that the rewards or points received in the offline game may be updated to the online environment. The personal communication device may be a tool for players to swap rewards and points with others offline. In a language learning context, the speech recognition engine further ensures that a player is speaking only in the language the player is learning, further facilitating the player's language learning.

Alternatively, the voice functions may be carried out in the form of a rhythm-based voice competition module in accordance with the present invention. The rhythm-based voice competition module may provide lyrics and graphics as learning contents. Additionally, the rhythm-based voice competition module may provide animated accessory objects, such as apron critters, mitten critters, etc. When the animated accessory objects are encountered by a player, the player may launch his or her own animated accessory objects into the competition. Advantageously, rhythm helps with learning and moves the body. The rhythm-based voice competition module may selectively enable a speech recognition engine further enhancing the learning process. Additionally, the rhythm-based voice competition module may selectively enable time restriction. The rhythm-based voice competition module may provide reward points and/or avatar accessories depending on the result of the game. In one embodiment, the rhythm-based voice competition is between a player and a non-player character. In another embodiment, the game module is for competition between online players.

In accordance with the present invention, the game plan may include a parent-and-kid platform. The parent-and-kid platform may include a blog as a communication channel between the parents, and children, a three-dimensional communication booklet for communication between the parents and the online facilitator, a reward program to give out virtual points or items for learning incentives, a parent-and-kid competition for increasing the communication between the parents and the kids, a learning history and inquiry as a track record for each individual learner, and a parental monitoring client program for parents to watch over the contents being experienced by their children in real-time.

In accordance with the present invention, the interactive learning method may be user-oriented, and designed with a natural learning approach, a direct teaching approach, a group learning approach, a speaking and listening approach, or any combination thereof. The program may be designed with computer-assisted instruction in the form of drill and practice, tutorial, or simulation activities.

In accordance with the present invention, a helper system is provided. The helper system may act as an in-game hint system. The helper system may also provide voice help to assist the players in adventures or missions.

The present invention may also provide additional key features such as individualized avatars and pets, a variety of in-game collections, mini games and side quests, group competition, secret levels, special rewards or any combination thereof so as to motivate the players to learn interactively.

In accordance with the present invention, the interactive learning system utilizing the MMOPRG may integrate voice over IP, automatic speech recognition (ASR), text-to-speech (TTS) function, back-end system, hardware IC, knowledge management, or real-time event editor to facilitate interaction. Integrating voice over IP and ASR as well as TTS may further help players who are learning a foreign language to improve their speaking skills in addition to listening and reading skills. As a result, learners may enhance their overall language skills utilizing the massively multiplayer online game.

Additionally, the interactive learning system may include a main interface showing a player avatar, other player avatar, a learning level indicator, a communication window, a reward point indicator, a FABO or any combination thereof. The main interface may further show the map and mission indicator and the function menu icon of the FABO. As a result, the learning experience may be as pleasant as playing online games.

In accordance with the present invention, a digital signal processor may be provided to integrate voice over IP and speech recognition on the same chip so as to achieve the best learning result utilizing the massively multiplayer online game. This integrated digital signal processor will be incorporated in the personal communication device (PCD) for use with the massively multiplayer online game; as a result, less system resource is needed on user's PC, thereby reducing the loading on the PC. Depending on the need, text-to-speech may also be integrated onto the same chip to further achieve the best learning result utilizing the massively multiplayer online game.

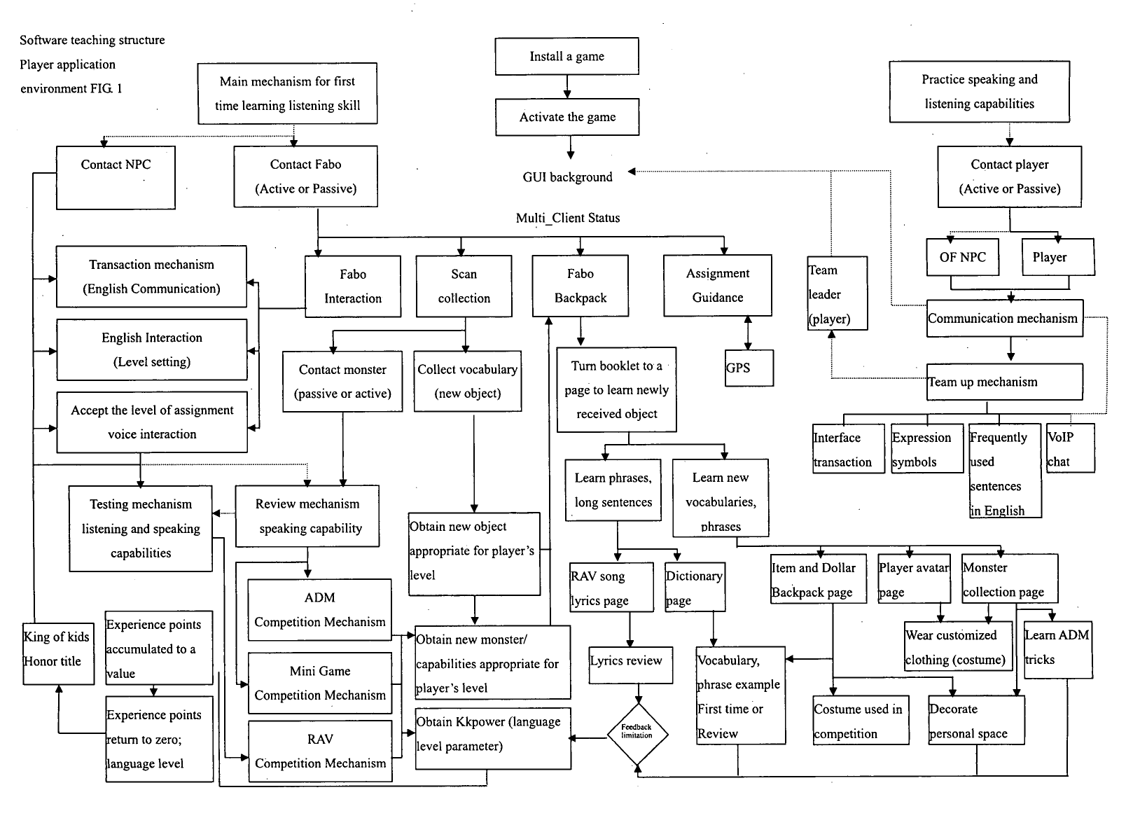

FIG. 1 shows a flow chart of the interactive learning method in an embodiment of the present invention. In the embodiment, a foreign language learning in the MMORPG environment is shown illustratively. The interactive learning method starts at installing a software game at a learner side. The learner may also be referred to as the user or the player. Then, the learner may start the game by, for example, logging on to the Internet and launching a computer client program the same way as he or she would play an online game. In a preferred embodiment, the learner is logged on to the online program where multiple learners are also currently logged onto. Additionally, at least one non-player character (real and/or artificial intelligence), such as an online facilitator, may be available to contact and be contacted by the learner in the learning environment at any given time.

In the embodiment where English is taught, the online facilitator may be a native English speaker providing all kinds of interaction with the player. Particularly, in a scenario where listening skill is to be emphasized, the online facilitator may actively approach the player to provide opportunities for the player to listen. The online facilitator may conduct a variety of transaction with the player using the foreign language, such as English, so that the player may practice his or her speaking, writing and/or reading skill in addition to the listening skill through interaction with the online facilitator.

The interaction may be set with different levels of difficulties such that the player may master a given level of difficulty before advancing to the next level. The player may also be given tasks corresponding to the appropriate level of difficulty such that by completing the given tasks the player is allowed to practice his or her communication skills in the specific foreign language. Then, a testing mechanism may be initiated to test the player's listening and speaking capabilities. One such testing mechanism is through the rhythm-based voice competition mentioned above. Additionally, a review mechanism may be initiated to help practicing the player's speaking skill. An example of such review mechanism may be a question and answering mini game sequence between the player and online facilitator (or artificial intelligence). In addition to the rhythm-based voice competition mentioned above, the animated objects such as a special monster mentioned before may also be utilized to help improve the player's speaking skill. To motivate the player, a reward program may be set up.

Alternatively, the player may be approached by other players such that listening skill as well as speaking skill can be learned while making friends in the learning environment. The player may conduct a variety of transaction with the other player using the foreign languages, such as English, so that the player may practice his or her speaking, listening, writing and or reading skill through interaction with the other online player the same way as they interact with the online facilitator and artificial intelligence and the same way they would interact with people in the real world using their native language in a natural learning environment. The interaction may also be set with different levels of difficulties such that the player may master a given level of difficulty before advancing to the next level.

The player may also team up with other players having similar level of skill and be given tasks corresponding to the appropriate level of difficulty such that by completing the given tasks, the players are allowed to practice his or her communication skills in the specific foreign language and in the appropriate level.

In accordance with the present invention, the player may scan objects with the help of their FABOs in the game. The FABOs may help collect vocabularies, phrases, sentences, usages and grammars, and in turn these vocabularies, phrases, sentences, usages and grammars may further be used in the variety of competitions as mentioned above. The player may receive new items, animated objects, or reward points corresponding to the player's level in response to a competition result. These new items, animated objects and reward points may also be used on the FABO as the player's resource to accomplish certain tasks.

In accordance with the present invention, the interactive learning method may provide a virtual backpack where new items, new vocabularies, phrases, sentences, usages, grammars and/or new animated objects may be stored. The virtual backpack may automatically present the new items, vocabularies, phrases, sentences, usages, grammars and animated objects as needed such that the player may learn these things as they occur.

In a scenario where phrases and long sentences are presented, the game module may incorporate these phrases and long sentences into a rhythm-based or turn-based voice competition so that the player may learn these phrases and sentences as lyrics of theme songs or action commands. The phrases and sentences may be repeatedly played as theme songs or being selected by the computer for the players to repeat and to get familiarize with them. Alternatively, the virtual backpack may present a dictionary page, allowing the player to understand the meaning of any vocabularies, phrases, sentences, usages and grammars. Depending on the number of practice done, appropriate reward points may be allocated to the player. Once the reward points reach a predetermined level, the player may be rewarded with a prize and/or the player is advanced to the next level of learning.

In a scenario where new vocabularies and or phrases are learned, a virtual backpack page filled with items and dollar amounts may be presented. The items and dollar amounts may be used as resources in competition, acquisition of additional items, as well as decoration of personal space and/or image. Additionally, a player avatar page may be presented or a FABO collection page may be presented. The player avatar and/or his FABO may be wearing customized clothing and costume. The player may also learn voice action sequence for competition purpose.

In accordance with the present invention, the MMOPRG may provide a quest system incorporating GPS to provide vivid interaction with the rest of the learning environment.

In accordance with the present invention, when speaking and listening skills are to be emphasized, the player may either approach an online facilitator or another online player actively, or be approached by the online facilitator or other online players. Due to the interactive nature of the MMOPRG platform, communication among the players may be greatly facilitated. The players may also form groups to accomplish assignments together. To personify the communication, symbols of facial expression, frequently used sentences, as well as character animation may be created and/or exchanged, a variety of interfaces may also be traded between the players; the players may chat using VoIP such that speaking skills may be practiced.

Depending on the type of skills the player wishes to learn, such as listening or speaking, games emphasized on such skills may be played. Since the interactive learning method utilizes the MMORPG as the learning platform, the player may log on to initiate the software game any time and anywhere. Furthermore, the player may interact with different online players each time he or she enters the game and encounter different scenarios, tasks, vocabularies, usages, etc. but at the same time the player may consistently learn at an appropriate level as provided by the historical record. This way, the players may not easily get bored with learning; instead, they may learn naturally as if they are playing games.

In accordance with the present invention, the interactive learning system may incorporate virtual and real environments, thereby generating a quasi-natural learning platform. For example, the learning platform may be depicted as an English-speaking community, allowing players to do activities and/or transactions in English and in real life. Additionally, the exemplary English-speaking community may hold various events to further encourage players to communicate with each other in English. The interactive learning system may further provide a customer service mechanism to help players solve problems or answer players' questions directly. In a preferred embodiment of the present invention, the interactive learning system may allow any number of players to log on to the system at any given time. Additionally, the interactive learning system may be updated regularly so as to constantly create excitement for the players; the interactive learning system may also provide upgradeable learning contents. Furthermore, the interactive learning system may provide a story-driven learning method so as to enhance online interaction among the players and online facilitators. The story-driven learning method may also create special scenarios to help players with lower points to improve their skills. In one embodiment of the present invention, the interactive learning system may allow the players to learn a foreign language in practical context environments. For example, virtual items received in the learning environment may be exchanged in the same way items are exchanged in the real world.

While the invention has been described in conjunction with exemplary preferred embodiments, it is to be understood that many alternatives, modifications, and variations will be apparent to those skilled in the art in light of the foregoing description. For example, in addition to language learning, other types of learning may also benefit from this MMORPG platform. For example, a businessperson may learn the rules of a certain industry before facing a major client, performing a challenging task or switching jobs. Accordingly, the present invention embraces all such alternatives, modifications, and variations. All matters set forth herein or shown in the accompanying drawings are to be interpreted in an illustrative and non-limiting sense.

What is claimed is:

1. A language learning method, comprising:
providing a persistent environment such that when a player enters said persistent environment, an interaction between said player and said persistent environment is based on said player's level of a language skill.

2. The method of claim 1, further comprising:
integrating a voice over IP (VoIP) function, an automatic speech recognition (ASR) function, a text-to-speech (TTS) function, or any combination thereof into said persistent environment such that said language skill can be performed through voice.

3. The method of claim 1, wherein said persistent environment is a massively multiplayer online role-playing game (MMORPG) having an avatar representing said player.

4. The method of claim 3, wherein an avatar controlled by a language facilitator initiates said interaction with said avatar representing said player so as to help develop said language skill.

5. The method of claim 1, wherein a plurality of players entering said persistent environment has the same level of said language skill or a different level of said language skill.

6. The method of claim 1, wherein said persistent environment includes a three-dimensional virtual scene, multiple players, a virtual role play, a virtual pet system, a virtual economy, a virtual group of character, a set of adventure quests, a game, a competition, a set of events, a user customizable avatar, a user customizable virtual space, a parent-and-kid platform, a helper system, or any combination thereof.

7. The method of claim 1, further comprising:
providing a plurality of learning modules operative to provide learning materials in response to said interaction between said player and said persistent environment, wherein said learning materials include vocabularies, phrases, sentences, usages, and grammars shown for said player to speak or spell out in said language.

8. An interactive learning method, comprising:
providing a virtual world mimicking a real world wherein a player represented by an avatar chooses a destination to visit so as to learn a language during said visit in said virtual world based on said player's level of said language.

9. The method of claim 8, wherein said destination is a city in said real world.

10. The method of claim 8, further comprising:
integrating a voice over IP (VoIP) function, an automatic speech recognition (ASR) function, a text-to-speech (TTS) function, or any combination thereof into said virtual world such that said language can be learned through voice.

11. The method of claim 8, wherein said virtual world has a plurality of players represented by a respective avatar to initiate an interaction with said player in said language.

12. The method of claim 8, wherein said player performs a transaction in said virtual world using said language as if said player performs said transaction in said real world.

13. A language learning method, comprising:
providing a persistent environment having a plurality of learning modules such that when a player enters said persistent environment, said plurality of learning modules provides learning materials in response to an interaction between said player and said persistent environment based on said player's level of a language skill.

14. The method of claim 13, further comprising:
integrating a voice over IP (VoIP) function, an automatic speech recognition (ASR) function, a text-to-speech (TTS) function, or any combination thereof into said persistent environment such that said language skill can be performed through voice.

15. The method of claim 13, wherein said persistent environment includes a three-dimensional virtual scene, multiple players, a virtual role play, a virtual pet system, a virtual economy, a virtual group of character, a set of adventure quests, a game, a competition, a set of events, a user customizable avatar, a user customizable virtual space, a parent-and-kid platform, a helper system, or any combination thereof.

16. The method of claim 13, wherein said learning materials include vocabularies, phrases, sentences, usages, and grammars shown for said player to speak or spell out in said language.

17. The method of claim 13, wherein an avatar controlled by a language facilitator initiates an interaction with said player based on said player's level of said language skill.

18. A language learning system, comprising:
means for providing a persistent environment wherein when a player enters said persistent environment, an interaction between said player and said persistent environment is based on said player's level of a language skill.

19. The system of claim 18, further comprising:
means for integrating a voice over IP (VoIP) function, an automatic speech recognition (ASR) function, a text-to-speech (TTS) function, or any combination thereof into said persistent environment such that said language skill can be performed through voice.

20. The system of claim 18, wherein said persistent environment is a massively multiplayer online role-playing game (MMORPG) having an avatar representing said player.

21. The system of claim 18, further comprising:
a plurality of learning modules operative to provide learning materials in response to said interaction between said player and said persistent environment.

22. The system of claim 21, wherein said learning materials include vocabularies, phrases, sentences, usages, and grammars shown for said player to speak or spell out in said language.

23. The system of claim 18, wherein said persistent environment includes a three-dimensional virtual scene, multiple players, a virtual role play, a virtual pet system, a virtual economy, a virtual group of character, a set of adventure quests, a game, a competition, a set of events, a user customizable avatar, a user customizable virtual space, a parent-and-kid platform, a helper system, or any combination thereof.

24. The system of claim 18, wherein an avatar controlled by a language facilitator initiates an interaction with said player based on said player's level of said language skill.

25. A digital signal processor, comprising:
a voice over IP (VoIP) function, an automatic speech recognition (ASR) function, a text-to-speech (TTS) function, or any combination thereof integrated onto a same chip so as to be utilized in said persistent environment of claim 1.

26. The method of claim 1, further comprising:
interacting with said persistent environment through a personal communication device so as to assist said player in learning.

27. The method of claim 26, wherein said personal communication device processes audio signals generated from a voice over IP (VoIP) function, an automatic speech recognition (ASR) function, a text-to-speech (TTS) function.

28. The method of claim 26, wherein said personal communication device provides learning modules when used in an offline status.

29. The method of claim 26, wherein said personal communication device synchronizes with said persistent environment when said personal communication device is used in an online status.

30. The method of claim 8, further comprising:
interacting with said virtual world through a personal communication device so as to assist said player in learning.

31. The method of claim 30, wherein said personal communication device processes audio signals generated from a voice over IP (VoIP) function, an automatic speech recognition (ASR) function, a text-to-speech (TTS) function.

32. The method of claim 30, wherein said personal communication device provides learning modules when used in an offline status.

33. The method of claim 30, wherein said personal communication device synchronizes with said virtual world when said personal communication device is used in an online status.

34. The method of claim 13, further comprising:
interacting with said persistent environment through a personal communication device so as to assist said player in learning.

35. The method of claim 34, wherein said personal communication device processes audio signals generated from a voice over IP (VoIP) function, an automatic speech recognition (ASR) function, a text-to-speech (TTS) function.

36. The method of claim 34, wherein said personal communication device provides said plurality of learning modules when used in an offline status.

37. The method of claim 34, wherein said personal communication device synchronizes with said virtual world when said personal communication device is used in an online status.

38. The system of claim 18, further comprising:
a personal communication device for interacting with said persistent environment so as to assist said player in learning.

39. The system of claim 38, wherein said personal communication device processes audio signals generated from a voice over IP (VoIP) function, an automatic speech recognition (ASR) function, a text-to-speech (TTS) function.

40. The system of claim 38, wherein said personal communication device provides learning modules when used in an offline status.

41. The system of claim 38, wherein said personal communication device synchronizes with said persistent environment when said personal communication device is used in an online status.

42. A personal communication device selectively used to interact with a persistent environment, said personal communication device comprising:
a main body utilized as a tool to interact with said persistent environment to assist a player in learning a language; and
a headset selectively used with said main body so as to provide audio capabilities;
a connecting base communicating with said main body and said headset so as to transmit an input to said persistent environment,
wherein said main body is installed with a digital signal processor of claim 25 such that said player interacts with said persistent environment through voice, and when said player is playing one of a plurality of learning modules within said persistent environment, said main body is plugged in said connecting base.

43. The personal communication device of claim 42, wherein said main body downloads said plurality of learning modules provided within said persistent environment such that said player can play said plurality of learning modules through said main body separately.

44. The personal communication device of claim 43, wherein said main body is unplugged from said connecting base when said player plays said plurality of learning modules through said main body separately.

45. The personal communication device of claim 42, wherein said main body synchronizes with said persistent environment to update rewards or points received by said player when said plurality of learning modules is played through said main body separately.

46. The personal communication device of claim 42, wherein said connecting base determines whether said headset is connected before said player enters said persistent environment.
